(19) United States
(12) Patent Application Publication
(10) Pub. No.: US 2019/0067986 A1
(43) Pub. Date: Feb. 28, 2019

(54) Distributed Energy Storage Systems

(71) Applicant: Saudi Arabian Oil Company, Dhahran (SA)

(72) Inventors: Mohamed Y. Haj-Maharsi, Dhahran (SA); Abdallah S. Guraishi, Dhahran (SA); Yasser A. AL-Howeish, Dhahran (SA)

(21) Appl. No.: 15/686,575

(22) Filed: Aug. 25, 2017

(51) Int. Cl. H02J 9/06; H01M 10/052; H01M 10/46; H01M 10/44; H02J 7/00

(52) U.S. Cl. CPC H02J 9/06; H01M 10/052; H02J 7/0068; H01M 10/446; H02J 9/062; H01M 10/46

(57) ABSTRACT

A distributed energy storage system includes a bi-directional rectifier configured to convert AC to DC and DC to AC, a battery pack connected in series with the bi-directional rectifier, the battery pack including a plurality of batteries connected in series, an inverter connected in series with the battery pack, wherein the inverter is configured to convert DC to AC, and a controller operatively connected to the battery pack and the bi-directional rectifier to control charging or discharging of the battery pack, wherein the controller is configured to determine that a level of charge in the battery pack is at or above a first threshold, and cause the battery pack to supply power to an electric utility grid that is connected in series to the bi-directional rectifier.

### TECHNICAL FIELD

Embodiments of the invention generally relate to distributed energy storage systems and, more specifically, to distributed energy storage systems employing UPS systems and methods for controlling the same.

### BACKGROUND

Robust power systems enable supplying power to one or more loads. Such power systems may include combinations of generation, transport, rectification, inversion and conversion of power to supply energy for electronic, optical, mechanical, and/or nuclear applications and loads. When implementing power systems and architectures, practical considerations include cost, size, reliability, and ease of implementation.

In at least some known power systems, one or more uninterruptible power supplies (UPSs) facilitate supplying power to a load. UPSs facilitate ensuring that power is continuously supplied to one or more critical loads, even when one or more components of a power system fail. Accordingly, UPSs provide a redundant power source. UPSs may be utilized in a number of applications (e.g., utility substations, industrial plants, marine systems, high security systems, hospitals, datacomm and telecomm centers, semiconductor manufacturing sites, nuclear power plants, etc.). Further, UPSs may be utilized in high, medium, or low power applications. For example, UPSs may be used in relatively small power systems (e.g., entertainment or consumer systems) or microsystems (e.g., a chip-based system).

As energy consumption outpaces energy supply, power quality and stability problems may be encountered. Further, energy costs may increase during periods of peak demand. Moreover, at least some renewable energy generation systems (e.g., photovoltaic, wind power) may present additional grid stability problems. Accordingly, to protect sensitive equipment against power quality events (e.g., outages, swells, sags, noise, etc.), UPSs are utilized to provide reliability.

### SUMMARY

One example embodiment is a distributed energy storage system including a bi-directional rectifier configured to convert AC to DC and DC to AC, a battery pack connected in series with the bi-directional rectifier, the battery pack including a plurality of batteries connected in series, an inverter connected in series with the battery pack, wherein the inverter is configured to convert DC to AC, and a controller operatively connected to the battery pack and the bi-directional rectifier to control charging or discharging of the battery pack. The controller may be configured to determine that a level of charge in the battery pack is at or above a first threshold, and cause the battery pack to supply power to an electric utility grid that is connected in series to the bi-directional rectifier. According to one example embodiment, the batteries may include an Uninterruptible Power Supply (UPS) system. The inverter may be connected in series to a load for supplying power to the load, and the controller is further configured to determine that the grid is down or the load is above a predetermined threshold, and cause the battery pack to supply power to the load. The controller may be further configured to determine that the level of charge in the battery pack is below the first threshold, and cause the battery pack to receive power from the grid, thereby charging the battery pack. The controller may also be configured to determine that the level of charge in the battery pack is below a second threshold, and cause to generate an alert indicating unsafe operation of the energy storage system. The specific-energy of the batteries may be at least 250 Wh/Kg. A maximum continuous charge/discharge rate of the batteries may be at least 1C. The batteries can include at least one of a lithium ion, lithium titanate, lithium cobalt oxide, lithium iron phosphate, lithium ion manganese oxide, lithium nickel manganese cobalt oxide, lithium nickel cobalt aluminum oxide battery, flow batteries, and fuel cells.

Another example embodiment is a method for supplying energy to an electric grid. The method may include connecting a bi-directional rectifier in series with a battery pack, the bi-directional rectifier configured to convert AC to DC and DC to AC, and the battery pack including a plurality of batteries connected in series, connecting an inverter in series with the battery pack, wherein the inverter is configured to convert DC to AC, and connecting a controller to the battery pack and the bi-directional rectifier to control charging or discharging of the battery pack. The controller may be configured to determine that a level of charge in the battery pack is at or above a first threshold, and cause the battery pack to supply power to an electric utility grid that is connected in series to the bi-directional rectifier. The method may also include connecting the inverter in series to a load for supplying power to the load, wherein the controller is further configured to determine that the grid is down or the load is above a predetermined threshold, and cause the battery pack to supply power to the load. The method may also include determining, by the controller, that the level of charge in the battery pack is below the first threshold, and causing, by the controller, the battery pack to receive power from the grid, thereby charging the battery pack. The method may further include determining, by the controller, that the level of charge in the battery pack is below a second threshold, and causing, by the controller, to generate an alert indicating unsafe operation of the energy storage system. The specific-energy of the batteries may be at least 250 Wh/Kg. A maximum continuous charge/discharge rate of the batteries may be at least 1 C. The batteries can include at least one of a lithium ion, lithium titanate, lithium cobalt oxide, lithium iron phosphate, lithium ion manganese oxide, lithium nickel manganese cobalt oxide, lithium nickel cobalt aluminum oxide battery, flow batteries, and fuel cells.

Another example embodiment is a distributed energy storage system including a bi-directional rectifier configured to convert AC to DC and DC to AC, a Uninterruptible Power Supply (UPS) connected in series with the bi-directional rectifier, an inverter connected in series with the UPS, wherein the inverter is configured to convert DC to AC, and a controller operatively connected to the UPS and the bi-directional rectifier to control charging or discharging of the UPS. The controller may be configured to determine that a level of charge in the UPS is at or above a first threshold, and cause the UPS to supply power to an electric utility grid that is connected in series to the bi-directional rectifier. According to one example embodiment, the specific-energy of the UPS may be at least 250 Wh/Kg. A maximum continuous charge/discharge rate of the UPS may be at least 2 C. The UPS may include at least one of a lithium ion, lithium titanate, lithium cobalt oxide, lithium iron phosphate, lithium ion manganese oxide, lithium nickel manganese cobalt oxide, lithium nickel cobalt aluminum oxide battery, flow batteries, and fuel cells.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 is a schematic of a UPS system, according to prior art teachings.

FIG. 2 is a schematic of a distributed energy storage system, according to one or more example embodiments of the disclosure.

FIG. 3 is a schematic of a UPS network in a distributed energy storage system, according to one or more example embodiments of the disclosure.

FIG. 4 illustrates example operations in a method for supplying energy to a grid, according to one or more example embodiments of the disclosure.

### DETAILED DESCRIPTION

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

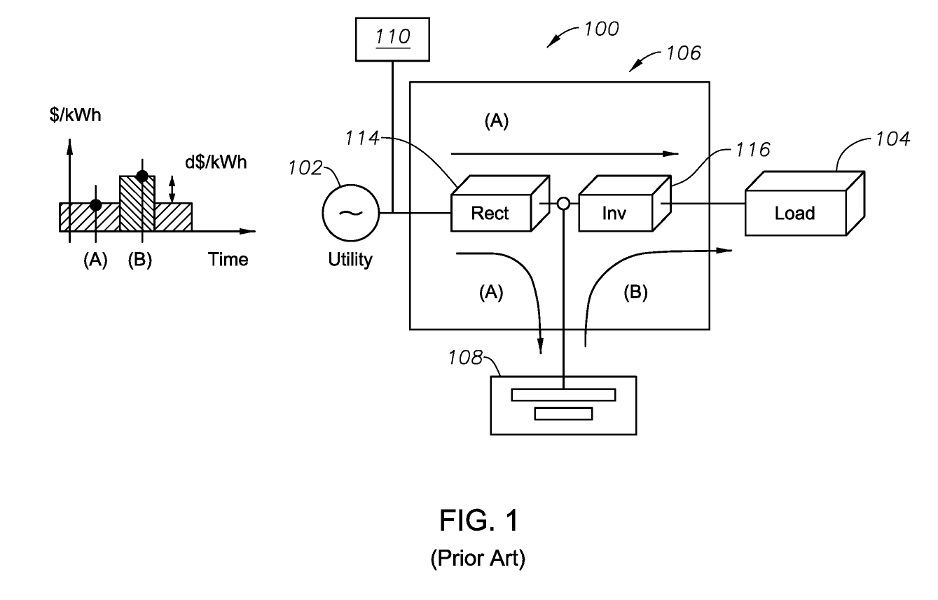

Turning now to the figures, FIG. 1 is a schematic diagram of a conventional power system 100 that supplies power from a grid 102 (e.g., a utility mains or power network) to a load 104 through a UPS 106. Load 604 may be, for example, a data center or a computer center for operating and managing a telecommunications system. An intermediate device 110 (e.g., an automatic transfer switch or a transformer) may be coupled between grid 102 and UPS 106. In additional to normal UPS functionalities, UPS 106 provides grid interactive functions. For example, the converters in UPS 106 may be operable to provide a controllable load that grid 102 sees. In yet another example, UPS 106 implements a peak shaving operating mode in which a critical load of UPS 106 is supplied from an internal energy storage device (e.g., a battery) of UPS 106 when energy costs are relatively high. The energy storage device is then recharged during low rate periods.

System 100 may optionally include a semiconductor switching module (SSM) (not shown), such as a thyristor-based component or a forced-commutation device (e.g., an integrated gate-commutated thyristor (IGCT)). Under normal load conditions, UPS 106 operates as described to provide improved current and voltage to load 104. When the system 100 uses a SSM it provides a bypass mode that bypasses operation of rectifier 114 and inverter 116.

FIG. 1 is a schematic diagram of system 100 in a peak shaving mode in which load 104 is supplied power from battery 108. Peak shaving mode may be implemented, for example, when the cost of energy from grid 102 is relatively high. Accordingly, cost savings may realized by supplying power to load 104 from battery 108 instead of grid 102. During low rate periods, when the cost of energy from grid 102 is lower, battery 108 is recharged by receiving power from grid 102 through rectifier 114. For example, as shown in FIG. 1, in an (A) state, the cost of energy is relatively low, and power is provided from grid 102 to battery 118 and to load 104. In contrast, in a (B) state, the cost of energy is relatively high, and load 104 receives power from battery 118.

Battery 118 is sized and configured to provide power during typical UPS autonomy (e.g., in situations where grid 102 fails), as well as during the peak shaving mode. The economical benefits of the peak shaving mode depends on the difference between the peak rate and normal rate for power from grid 102, the daily time length of the peak shaving mode, and any increased costs of the battery 118 to enable the peak shaving mode functionality. To switch between the normal mode and the peak shaving mode, a controller (not shown) coupled to UPS 106 may compare the current energy rate to the normal energy rate to determine whether the peak shaving mode should be activated. For example, UPS 100 may switch to a peak shaving mode when the current energy rate exceeds a predetermined rate.

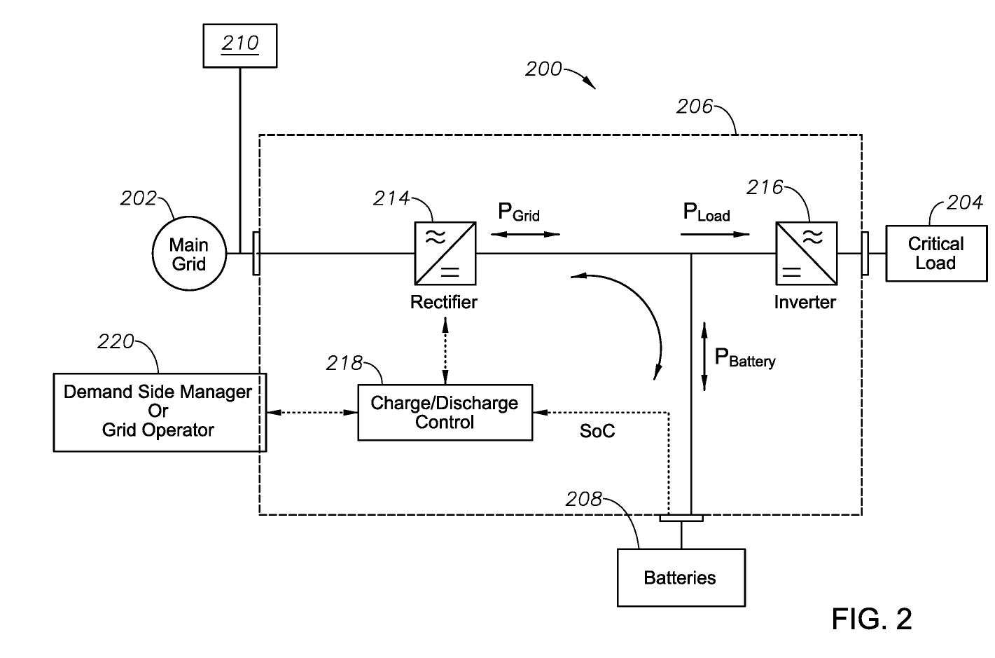

FIG. 2 is a schematic diagram of a distributed energy storage system 200, according to one or more example embodiments of the present disclosure. System 200 may include a bi-directional rectifier 214 configured to convert AC to DC and DC to AC. The system 200 may also include a UPS 206 including battery pack 208 connected in series with the bi-directional rectifier 214. The battery pack 208 may include a plurality of batteries connected in series, for example. The system may also include an inverter 216 that may be connected in series with the battery pack 208. Inverter 216 is configured to convert DC to AC. System 200 may also include a controller 218 operatively connected to the battery pack 208 and the bi-directional rectifier 214 to control charging or discharging of the battery pack 208.

According to one example embodiment, UPS 206 may be utilized to provide power back to grid 202. More specifically, under some power source conditions, battery 208 supplies power to grid 202 through rectifier 214. At least one of active and reactive power is supplied to grid 202. By controlling a phase of injected current with respect to a grid voltage, rectifier 214 can inject a combination of active and reactive power into grid 202. To supply power back to grid 202, in the exemplary embodiment, battery 208 is a Lithium ion battery capable of continuous charge-discharge-cycling. Battery 208 remains relatively unaffected by an ambient temperature, and is relatively compact. Alternatively, battery 208 may be any energy storage device that enables system 200 to function as described herein. The cycling of battery is controlled by a controller 208. As shown in FIG. 2, battery 208 may provide power to grid 202 through rectifier 214, and may also provide power to load 204 through inverter 216.

In some embodiments, the controller 218 may be configured to determine that a level of charge in the battery pack 208 is at or above a first threshold, for example 50%, and cause the battery pack 208 to supply power to the electric utility grid 202 that is connected in series to the bi-directional rectifier 214. According to one example embodiment, the batteries 208 may include an Uninterruptible Power Supply (UPS) system. The inverter 216 may be connected in series to a load 204 for supplying power to the load 204, and the controller 218 may be further configured to determine that the grid 202 is down or the load 204 is above a predetermined threshold, and cause the battery pack 208 to supply power to the load 204. The controller 218 may be further configured to determine that the level of charge in the battery pack 208 is below the first threshold, for example 50%, and cause the battery pack 208 to receive power from the grid 202, thereby charging the battery pack 208. The controller 218 may also be configured to determine that the level of charge in the battery pack 208 is below a second threshold, for example 20%, and cause to generate an alert indicating unsafe operation of the energy storage system 200 to a demand side manager or grid operator 220. The specific-energy of the batteries 208 may be at least 250 Wh/Kg, and a maximum continuous charge/discharge rate of the batteries 208 may be at least 1C. The batteries 208 can include at least one of a lithium ion, lithium titanate, lithium cobalt oxide, lithium iron phosphate, lithium ion manganese oxide, lithium nickel manganese cobalt oxide, and lithium nickel cobalt aluminum oxide battery.

System 200 may optionally include a semiconductor switching module (SSM) (not shown), such as a thyristor-based component or a forced-commutation device (e.g., an integrated gate-commutated thyristor (IGCT)). Under normal load conditions, UPS 206 operates as described above to provide improved current and voltage to load 204. When the system 200 uses a SSM it provides a bypass mode that bypasses operation of rectifier 214 and inverter 216. An intermediate device 210 (e.g., an automatic transfer switch or a transformer) may be coupled between grid 202 and UPS 206. In additional to normal UPS functionalities, UPS 206 provides grid interactive functions. For example, the converters in UPS 206 may be operable to provide a controllable load that grid 202 sees. In yet another example, UPS 206 implements a peak shaving operating mode in which a critical load of UPS 206 is supplied from an internal energy storage device (e.g., a battery) of UPS 206 when energy costs are relatively high. The energy storage device is then recharged during low rate periods. Each UPS 206 is considered a system on its own and operates independently from other UPS systems. To ovoid hunting problems of nearby controllers, a droop control strategy can be implemented in parallel UPSs located within short electrical distances. Droop control is one example way to achieve the power sharing of parallel inverter units in the UPSs. The so-called droop control means that the output voltage command of the inverter unit varies as the output power changes, and typically manifests as a drooping curve. Other methodologies that may be used include concentrated control technique, master-slave control method, and power deviation control method, for example.

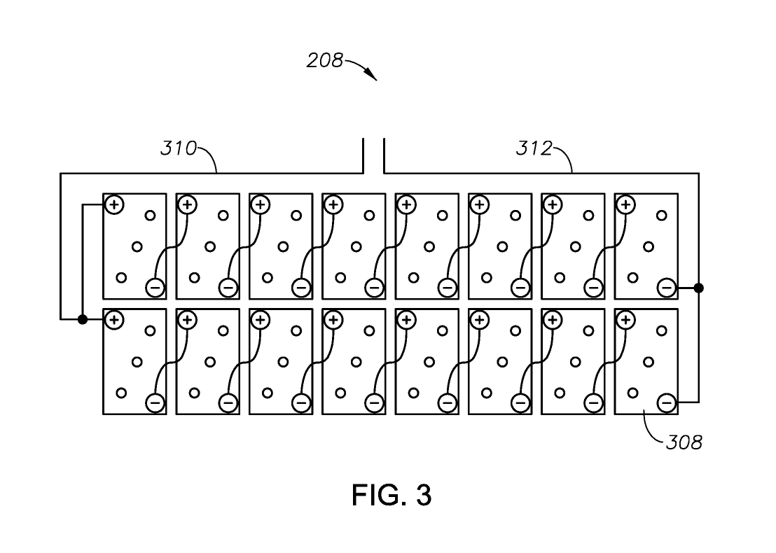

FIG. 3 is a schematic diagram of a battery pack 208 that may be used in the system 200 (FIG. 2), according to one or more example embodiments. Battery pack 208 may include a plurality of UPSs 308, which may be connected in series via terminals 310, 312. Each UPS 308 may include one or more batteries that may be connected in series or in parallel to supply power to the load 204. Each UPS 308 is considered a system on its own and operates independently from other UPS systems. To ovoid hunting problems of nearby controllers, a droop control strategy can be implemented in parallel UPSs located within short electrical distances. Droop control is one example way to achieve the power sharing of parallel inverter units in the UPSs. The so-called droop control means that the output voltage command of the inverter unit varies as the output power changes, and typically manifests as a drooping curve. Other methodologies that may be used include concentrated control technique, master-slave control method, and power deviation control method, for example.

The deployment of smart grid technology allows customers to efficiently and economically manage their energy consumption by controlling load connection throughout the day. The objective is to use less energy during peak hours, or to move the time of energy use to off-peak times such as nighttime and weekends. Peak demand management does not necessarily decrease total energy consumption, but could reduce the need for investments in transmission systems and power plants. The integration of renewable energy adds an extra parameter in the power management arena since power produced by renewable is intermittent and might not always coincide with energy demand. Even though load side management can mitigate intermittence, it is not always feasible to apply since the timing of intermittence is not known in advance. The best way to mitigate this problem is to use energy storage system 200 as a dynamic load so excess power can be stored and re-injected to the grid as needed.

Existing energy storage projects consist of centralized utility scale systems that require high investment costs but do not allow individual customers to manage their own energy intakes. Distributed energy storage system 200, however, when installed at the customer premises allows them to store energy and re-inject it back to the grid as needed. This approach, provides incremental investment cost and better reliability through redundancy. As UPS systems are already wide spread and located at customer's premises, their adaptation for use as distribute energy devises rivals the idea of using conventional systems for the same purpose. Minor changes in specifications of new acquired UPS systems or retrofitting existing ones allow the deployment of a huge capacity of storage to help with power management in the grid.

Embodiments of the present invention use an existing UPS system, modifies its front-end converter from unidirectional converter to bidirectional converter, and controls power direction from and to the grid based on the state of charge of the battery banks and the grid voltage.

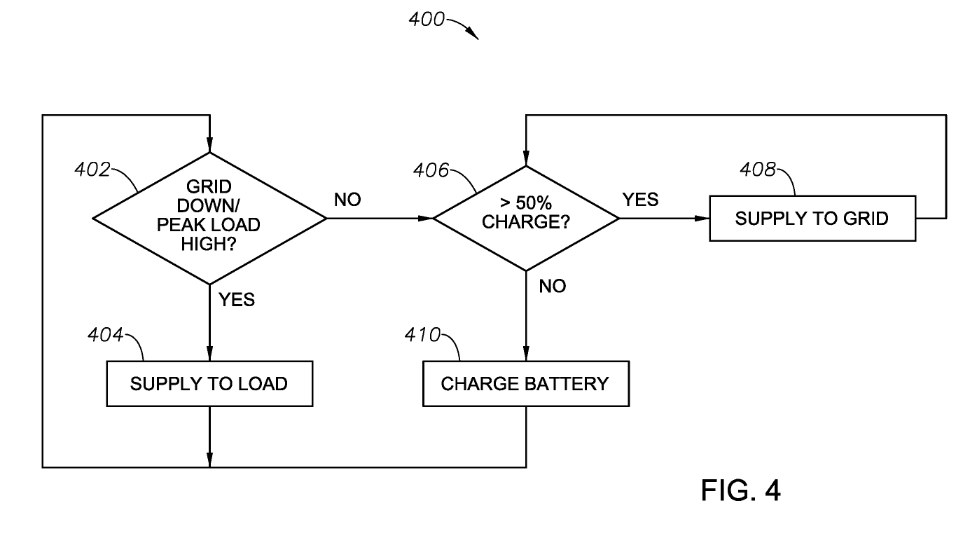

FIG. 4 illustrates example operations in a method 400 for supplying energy to an electric grid, according to one or more example embodiments. The method 400 may include connecting a bi-directional rectifier in series with a battery pack, the bi-directional rectifier configured to convert AC to DC and DC to AC, and the battery pack including a plurality of batteries connected in series. The method may also include connecting an inverter in series with the battery pack, wherein the inverter is configured to convert DC to AC. The method may further include connecting a controller to the battery pack and the bi-directional rectifier to control charging or discharging of the battery pack. The method may also include connecting the inverter in series to a load for supplying power to the load. The controller, in one example embodiment, may be configured to determine that the grid is down or the load is above a predetermined threshold at step 402, and cause the battery pack to supply power to the load at step 404. If the grid is not down and the load is not above the predetermined threshold, the controller determines, at step 406, if a level of charge in the battery pack is at or above a first threshold, for example 50%. If the level of charge in the battery pack is at or above the first threshold, then the controller causes the battery pack to re-inject or supply power to an electric utility grid that is connected in series to the bi-directional rectifier, at step 408. The method 400 may also include determining, by the controller, that the level of charge in the battery pack is below the first threshold, at step 409, and causing the battery pack to receive power from the grid, thereby charging the battery pack at step 410. The method may optionally include determining, by the controller, that the level of charge in the battery pack is below a second threshold, for example 20%, and causing, by the controller, to generate an alert indicating unsafe operation of the energy storage system to either the demand side manager or grid operator.

In addition, it should be appreciated that the operations described and depicted in FIG. 4 may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIG. 4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Given the wide installation base of UPS systems, the available batteries can be utilized as distributed energy storage devices in conjunction with renewable energy, such as wind and solar. In order to use the UPS batteries as distributed energy devices without impairing the primary function of the UPS, however, the following characteristics should be made available: high cycling and high charging and discharging rates as provided by Lithium ion or Lithium Titanate batteries, for example. These types of batteries also provide safe operation down to 20% of the State of Charge (SoC). So 50% of the operating range can be used for grid applications and 30% can be used for emergency power. A bidirectional rectifier to allow batteries to discharge into the main grid when needed and within specific SoC preset limits. A charge discharge mechanism may be employed that decides when to charge the batteries and when to return power to the main grid. Distributed energy storage, however, when installed at the customer premises allow them to store energy and re-inject it back to the grid as needed. This approach provides incremental investment cost and better reliability through redundancy. As UPS systems are already wide spread and located at customers' premises, their adaptation for use as distribute energy devises rivals the idea of using conventional systems for the same purpose. Minor changes in specifications of new acquired UPS systems or retrofitting existing ones can allow the deployment of a huge capacity of storage to help with power management in the grid.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

1. A distributed energy storage system comprising:
a bi-directional rectifier configured to convert AC to DC and DC to AC;
a battery pack connected in series with the bi-directional rectifier, the battery pack comprising a plurality of batteries connected in series;
an inverter connected in series with the battery pack, wherein the inverter is configured to convert DC to AC; and
a controller operatively connected to the battery pack and the bi-directional rectifier to control charging or discharging of the battery pack, wherein the controller is configured to:
determine that a level of charge in the battery pack is at or above a first threshold; and
cause the battery pack to supply power to an electric utility grid that is connected in series to the bi-directional rectifier.

2. The system according to claim 1, wherein the plurality of batteries comprise an Uninterruptible Power Supply (UPS) system.

3. The system according to claim 1, wherein the inverter is connected in series to a load for supplying power to the load, and the controller is further configured to:
determine that the grid is down or the load is above a predetermined threshold; and
cause the battery pack to supply power to the load.

4. The system according to claim 1, wherein the controller is further configured to:
determine that the level of charge in the battery pack is below the first threshold; and
cause the battery pack to receive power from the grid, thereby charging the battery pack.

5. The system according to claim 1, wherein the controller is further configured to:
determine that the level of charge in the battery pack is below a second threshold; and
cause to generate an alert indicating unsafe operation of the energy storage system.

6. The system according to claim 1, wherein the specific-energy of the batteries is at least 250 Wh/Kg.

7. The system according to claim 1, wherein a maximum continuous charge/discharge rate of the batteries is at least 1 C.

8. The system according to claim 1, wherein the batteries comprise at least one of a lithium ion, lithium titanate, lithium cobalt oxide, lithium iron phosphate, lithium ion manganese oxide, lithium nickel manganese cobalt oxide, and lithium nickel cobalt aluminum oxide battery.

9. A method for supplying energy to an electric grid, the method comprising:
connecting a bi-directional rectifier in series with a battery pack, the bi-directional rectifier configured to convert AC to DC and DC to AC, and the battery pack comprising a plurality of batteries connected in series;
connecting an inverter in series with the battery pack, wherein the inverter is configured to convert DC to AC; and
connecting a controller to the battery pack and the bi-directional rectifier to control charging or discharging of the battery pack, wherein the controller is configured to:
determine that a level of charge in the battery pack is at or above a first threshold; and
cause the battery pack to supply power to an electric utility grid that is connected in series to the bi-directional rectifier.

10. The method according to claim 9, wherein the plurality of batteries comprise an Uninterruptible Power Supply (UPS) system.

11. The method according to claim 9, further comprising:
connecting the inverter in series to a load for supplying power to the load, wherein the controller is further configured to:
determine that the grid is down or the load is above a predetermined threshold; and
cause the battery pack to supply power to the load.

12. The method according to claim 9, further comprising:
determining, by the controller, that the level of charge in the battery pack is below the first threshold; and
causing, by the controller, the battery pack to receive power from the grid, thereby charging the battery pack.

13. The method according to claim 9, further comprising:
determining, by the controller, that the level of charge in the battery pack is below a second threshold; and
causing, by the controller, to generate an alert indicating unsafe operation of the energy storage system.

14. The method according to claim 9, wherein the specific-energy of the batteries is at least 250 Wh/Kg.

15. The method according to claim 9, wherein a maximum continuous charge/discharge rate of the batteries is at least 1C.

16. The method according to claim 9, wherein the batteries comprise at least one of a lithium ion, lithium titanate, lithium cobalt oxide, lithium iron phosphate, lithium ion manganese oxide, lithium nickel manganese cobalt oxide, and lithium nickel cobalt aluminum oxide battery.

17. A distributed energy storage system comprising:
a bi-directional rectifier configured to convert AC to DC and DC to AC;
a Uninterruptible Power Supply (UPS) connected in series with the bi-directional rectifier;
an inverter connected in series with the UPS, wherein the inverter is configured to convert DC to AC; and
a controller operatively connected to the UPS and the bi-directional rectifier to control charging or discharging of the UPS, wherein the controller is configured to:
determine that a level of charge in the UPS is at or above a first threshold; and
cause the UPS to supply power to an electric utility grid that is connected in series to the bi-directional rectifier.

18. The system according to claim 17, wherein the specific-energy of the UPS is at least 250 Wh/Kg.

19. The system according to claim 17, wherein a maximum continuous charge/discharge rate of the UPS is at least 2C.

20. The system according to claim 17, wherein the UPS comprises at least one of a lithium ion, lithium titanate, lithium cobalt oxide, lithium iron phosphate, lithium ion manganese oxide, lithium nickel manganese cobalt oxide, and lithium nickel cobalt aluminum oxide battery.
